(19) United States
(12) Patent Application Publication
(10) Pub. No.: US 2025/0356164 A1
(43) Pub. Date: Nov. 20, 2025

(54) METHODS AND APPARATUS FOR MIXTURE OF EXPERTS (MoE) INFERENCE WITH FULL AND PARTIAL HOT EXPERT BUFFERS

(71) Applicant: Intel Corporation, Santa Clara, CA (US)

(72) Inventors: Min Jean Cho, Santa Clara, CA (US); Peng Zhao, Palo Alto, CA (US)

(73) Assignee: Intel Corporation, Santa Clara, CA (US)

(21) Appl. No.: 19/288,735

(22) Filed: Aug. 1, 2025

(51) Int. Cl. G06N 3/042

(52) U.S. Cl. CPC G06N 3/042

(57) ABSTRACT

An example apparatus includes interface circuitry, machine-readable instructions, and at least one processor circuit to be programmed by the machine-readable instructions to initialize a full hot expert buffer to store entire weights of an expert used with a first frequency, initialize a partial hot expert buffer to store partial weights of an expert used with a second frequency, wherein the first frequency is higher than the second frequency, identify a selected expert associated with a Mixture of Experts (MoE) layer of a Large Language Model (LLM), and perform a direct computation or a partially direct computation, the direct computation performed when the selected expert is stored in the full hot expert buffer, the partially direct computation performed when the selected expert is stored in the partial hot expert buffer.

### BACKGROUND

Large Language Model (LLM) efficiency and performance can be improved through application of a Mixture of Experts (MoE) architecture. The MoE partitions complex tasks associated with an artificial intelligence (AI) model into separate sub-networks that specialize in input data subsets, allowing the separate sub-networks to jointly perform a given task. Activating sub-networks instead of an entire neural network reduces computational costs associated with pre-training, achieving improved model performance during inference.

### BRIEF DESCRIPTION OF THE DRAWINGS

FIG. 1 illustrates an example expert usage account associated with a Mixture of Experts (MoE) model, including experts activated most frequently and experts activated with moderate frequency.

FIG. 2 illustrates storage of weights associated with the experts activated most frequently and the experts activated with moderate frequency of FIG. 1, including expert weight manager circuitry for storage and management of the expert weights in accordance with methods and apparatus disclosed herein.

FIG. 3 illustrates an example algorithm for the storage and management of expert weights performed using the expert weight manager circuitry of FIG. 2, including loading of weights into memory and decoding.

FIG. 4 illustrates an example comparison of expert hit rates using known caching techniques (e.g., Least Recently Used (LRU) caching) and global expert usage tracking disclosed herein.

FIG. 5 illustrates example distribution of expert usage counts based on update intervals, indicating effects of reset frequencies on expert usage distribution.

FIG. 6 represents an example heatmap illustrating an imbalance of expert usage based on identification of frequently activated experts and rarely used experts.

FIG. 7A illustrates an increase in expert hit rates using methods and apparatus disclosed herein for a total probability of selecting k hot experts set at β=0.5.

FIG. 7B illustrates an increase in expert hit rates using methods and apparatus disclosed herein for a total probability of selecting k hot experts set at β=0.2.

FIG. 8 is a block diagram of an example known implementation of the expert weight manager circuitry of FIG. 2.

FIG. 9 is a flowchart representative of example machine-readable instructions and/or example operations that may be executed, instantiated, and/or performed by example programmable circuitry to implement the example expert weight manager circuitry of FIG. 2.

FIG. 10 is a flowchart representative of example machine-readable instructions and/or example operations that may be executed, instantiated, and/or performed by the example expert weight manager circuitry of FIG. 2 to perform weight management based on global expert usage frequency.

FIG. 11 is a flowchart representative of example machine-readable instructions and/or example operations that may be executed, instantiated, and/or performed by the example expert weight manager circuitry of FIG. 2 to identify a full cache hit, a partial cache hit, or a no cache hit based on the selected expert(s).

FIG. 12 is a block diagram of an example processing platform including programmable circuitry structured to execute, instantiate, and/or perform the example machine readable instructions and/or perform the example operations of FIGS. 9-11 to implement the example expert weight manager circuitry of FIG. 2.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine readable instructions of FIGS. 9-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Large Language Models (LLMs) represent deep learning algorithms that can be used to recognize, summarize, predict, and/or generate content using large datasets. Application of LLMs permits artificial intelligence (AI)-based models to generate human-like content. Performance and efficiency of LLMs can be improved using a Mixture of Experts (MoE) architecture by relying on subnetworks to perform independent computations associated with a layer or operation of a neural network. Each subnetwork (e.g., expert) of the MoE represents an individual, specialized neural network within the MoE architecture that is trained to perform a specific subtask. The MoE includes a gating network to determine which experts are activated for a given input by mapping inputs to specific experts (e.g., dynamically selecting a subset of experts for each token), identifying experts to select during inference and/or training. Such expert subnetworks can be implemented on both dense MoE (e.g., including activation of all experts for every input) and sparse MoE (e.g., including activation of only a subset of experts for each input to improve efficiency). Once experts selected by the gating network independently process the input, outputs from individual active experts are aggregated to obtain the final output. As such, routing of different inputs to specialized experts allows the MoE to reduce computational costs compared to the use of dense models, with the specialized experts trained on different data subtasks or tasks to allow for a wider range of inputs. Using the specialized experts and gating network-based routing of inputs, MoE improves LLM-based efficiency and scalability for increasingly complex tasks. This reduces computational cost by activating only partial experts while enhancing performance with task specialization.

Although the MoE architecture has many parameters, only a fraction of these parameters are used during inference, making the MoE architecture significantly faster than dense models of similar size. However, all parameters are loaded into Random Access Memory (RAM) during inference, creating high memory demands. Deploying MoE on Artificial Intelligence (AI)-based PCs (e.g., Intel® Lunar Lake with a 16 gigabyte GPU memory) or consumer GPUs (e.g., Intel® Battlemage with 12 gigabyte GPU memory) presents a challenge, given that there is insufficient memory to hold the entire model, requiring frequent weight transfers between Central Processing Unit (CPU) and Graphics Processing Unit (GPU) memories. Parameter-offloading techniques typically transfer part of the model parameters to CPU memory or Solid-State Drives (SSDs) when GPU memory is insufficient. Most offloading systems (e.g., Zero-Infinity, Accelerate, etc.) can also load model parameters layer-by-layer on demand. While parameter offloading is suitable for models with predictable execution (e.g., storing model weights in slower memory and loading the weights into GPU memory on demand), such an approach is ineffective for MoE models due to dynamic expert selection, since on-demand expert loading cannot overlap with computation.

Other approaches include Least Recently Used (LRU) caching and cache-conditional experts. LRU caches K most-recently used experts per layer, introducing a scalability bottleneck for large models by requiring L×K experts in memory, where L represents the number of MoE layers (e.g., with DeepSeek V3, which has 58 layers and 256 experts/layer, a modest K=2 results in caching of 116 experts, where each expert weight is approximately 134 megabytes (67 million parameters having an FP16 data type), totaling 15.5 gigabytes of GPU memory solely for caching). As such, LRU-based caching is not possible for memory-constrained devices (e.g., AI PCs, etc.). Cache-conditional experts can be used to modify router logits to favor activating experts from the cached experts (e.g., AdapMoE dynamically adjusts expert gating and cache size while EdgeMoE formulates eviction policy based on per-layer statistics). However, these methods introduce complex changes to routing, gating, and cache management, making implementation difficult and less scalable. While techniques such as MoE-Infinity use Expert Activation Matrix Collection (EAMC) to predict expert selection, such techniques are more suitable when the set of hot experts (e.g., experts that are activated most frequently) is highly predictable. However, in real-world workloads, the specific set of hot experts changes dynamically over time, such that inaccurate predictions degrade model performance. Additionally, maintaining a historical EAMC data structure to track past activations requires additional memory overhead.

Methods and apparatus disclosed perform MoE inference with full and partial hot expert buffers. For example, methods and apparatus disclosed herein keep frequently used experts (e.g., hot experts) in a dedicated buffer to substantially increase the expert hit rate (e.g., a percentage of times the required expert for a given input is identified in the GPU memory or cache), reducing memory transfer overhead. Since the usage rate of experts varies significantly during inference, methods and apparatus disclosed herein introduce a specialized weight buffer (e.g., a hot expert buffer) that retains the most frequently used experts in dedicated high-speed memory (e.g., GPU memory or cache). In examples disclosed herein, experts in the hot expert buffer are selected based on a global expert usage across all layers, rather than a per-layer statistic, given that hot experts may not appear uniformly in every layer. As such, methods and apparatus disclosed herein introduce a novel weight management technique based on global expert usage frequency to increase expert hit rates and reduce weight transfer. Methods and apparatus disclosed herein improve GPU-to-CPU memory transfers as well as cache-to-global and CPU-to-disk memory transfers, making MoE models more efficient and practical for resource-constrained devices (e.g., AI PCs, consumer GPUs, etc.).

The dual-buffer implementation disclosed herein efficiently caches the full weights of a few dominantly hot experts and the partial weights of many moderately hot experts. Unlike per-layer caching, methods and apparatus disclosed herein select and cache experts globally across all layers, reducing memory overhead from frequent cache swaps and ensuring that the globally most frequent experts are stored. For example, while prior methods focus only on the highest-frequency experts, neglecting the large population of moderately frequent experts, methods and apparatus disclosed herein introduce the use of a partial buffer for expanding cached expert coverage at the same memory cost, caching a wide range of frequent experts. The partial buffer disclosed herein overlaps memory transfer with computation by prefetching asynchronously and hiding memory transfer latencies, while the use of a dual buffer as disclosed herein introduces full and partial caching that target both a small set of dominantly frequent experts and a large set of moderately frequent experts.

Compared to known caching techniques and/or expert selection techniques, methods and apparatus disclosed herein track global expert usage in real time, dynamically updating the set of hot experts as different experts become active. Such tracking can also be initiated during a prefill phase (e.g., initial stage of inference process when a model processes an input prompt), allowing for more accurate and effective expert selection during a decode phase (e.g., a stage of inference when the model generates output tokens). For example, in contrast to techniques that rely on EAMC to predict expert selection (e.g., MoE-Infinity), methods and apparatus disclosed herein dynamically track global expert usage with an L×N global counter, updating the set of hot experts as different experts become more active or less active. In contrast to cache-conditional experts, methods and apparatus disclosed herein directly increase expert hit rates by increasing the number of cached experts at the same memory cost through the storage of partial weights.

Methods and apparatus disclosed herein further perform caching of hot experts globally across all layers, maintaining a unified buffer of size K (e.g., For K=2, this reduces the memory requirement from 15.5 gigabytes to 536 megabytes, representing a substantial reduction in memory cost as compared to the use of LRU caching). As opposed to parameter offloading, hot expert buffers disclosed herein retain frequently used experts in high-speed dedicated buffers and enable overlapping compute with memory transfer via asynchronous prefetching in the partial hot expert buffer. Given that the AI PC and consumer GPU market is significantly larger than the data center market, with a growing number of end-users relying on their personal computers for daily tasks involving generative AI (GenAI), methods and apparatus disclosed herein can be used to achieve lower latency and the ability to run larger models than previously possible on consumer-grade hardware.

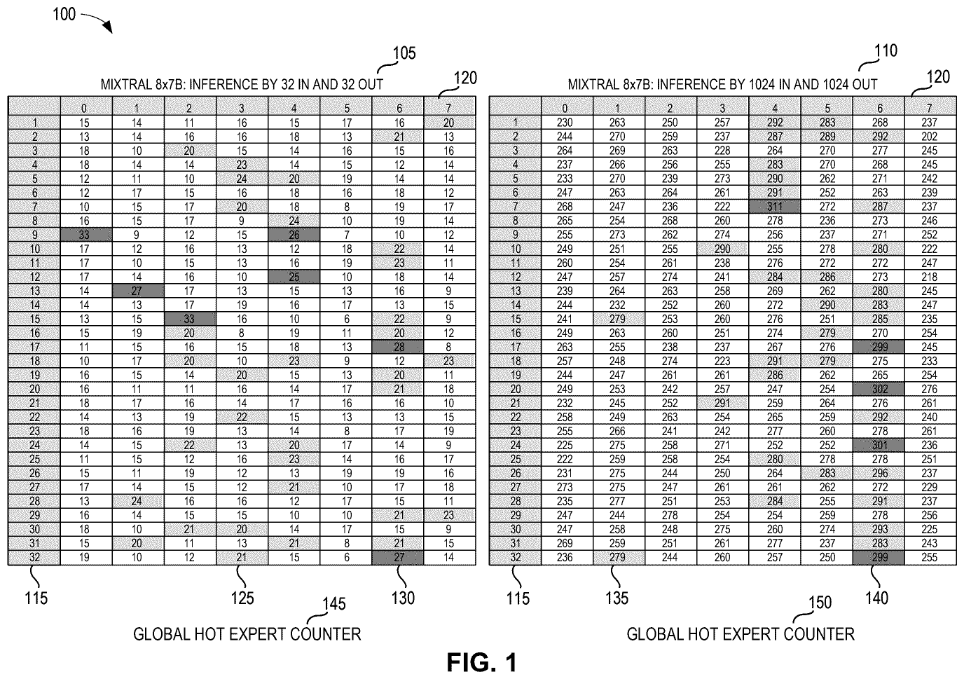

FIG. 1 illustrates example expert usage counts 100 associated with a Mixture of Experts (MoE) model, including experts activated most frequently (e.g., hot experts) and experts activated with moderate frequency (e.g., partial hot experts). For example, FIG. 1 includes experimental results 105, 110 showing the expert usage counts 100 from Mixtral-8x7B Large Language Models (LLM) (e.g., pretrained generative sparse MoEs), consisting of eight rows (e.g., rows 115) by thirty-two columns (e.g., columns 120) for a total of 256 independent experts in total. In the example of FIG. 1, columns 120 represent expert indices (e.g., expert indices 0 to 7) within each layer, while rows 115 represent the layer numbers (e.g., layers 1 to 32). The expert usage counts 100 are represented based on Mixtral-8×7B experimental results 105 (e.g., inference by 32 in and 32 out) representing 32 input/output sequence lengths and Mixtral-8x7B experimental results 110 (e.g., inference by 1024 in and 1024 out) representing 1024 input/output sequence lengths. Whereas the darker-shade boxes (e.g., boxes 130, 140) indicate dominantly hot experts (e.g., experts activated two standard deviations above the mean), the lighter-shade boxes (e.g., boxes 125, 135) indicate moderately hot experts (e.g., experts activated one standard deviation above the mean). As shown in the example of FIG. 1, while a small set of dominantly hot experts can be fully cached, a much larger set of moderately hot experts cannot all be fully cached due to memory limitations.

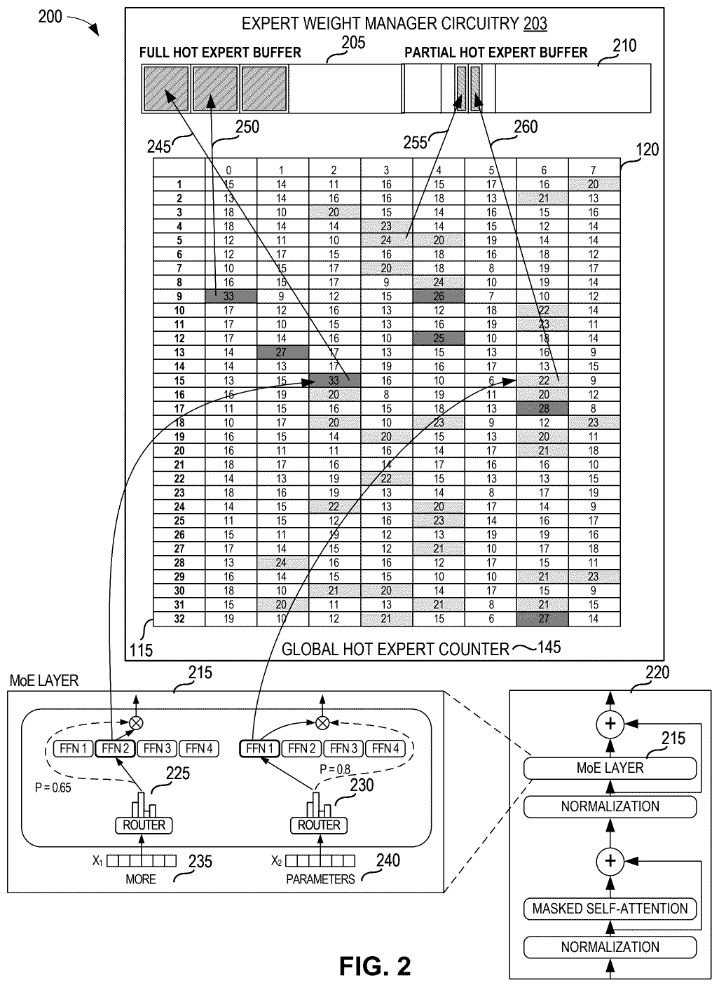

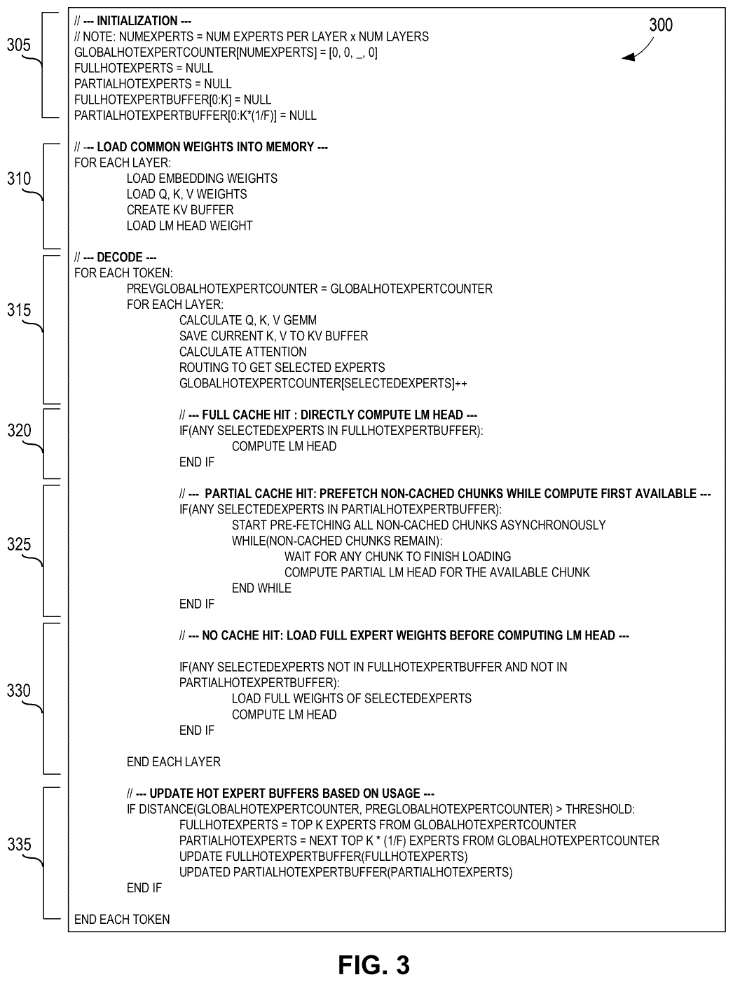

In the example of FIG. 1, the experimental results 105, 110 are summarized in the form of global hot expert counter(s) 145, 150 generated using global ranking, where global ranking indicates selection of hot experts based on rankings in the full L×N expert usage counter (e.g., where L represents a number of MoE layers and N represents a number of experts per MoE layer). For example, experts are ranked globally based on usage count, such that the (row, column) indications (9,0) and (9,4) in FIG. 1 represent hot experts within the same layer, while the (row, column) indications (17,6) and (32,6) of FIG. 1 represent hot experts across different layers. Such an approach allows for the selection of hot experts based on the global (from full L×N) rankings, both across and within layers, as opposed to using conventional per-layer selection. In examples disclosed herein, the most frequently activated experts, ranked globally across all layers, have significantly higher usage, making these experts ideal for full-weight storage in a full hot expert buffer. In contrast, moderately frequent experts are less dominant but far more numerous. As such, improving the hit rate of the moderately frequent experts is important because full caching of these experts is not possible due to GPU memory limitations. Methods and apparatus disclosed herein initiate (1) a full hot expert buffer for storing entire hot expert weights and (2) a partial hot expert buffer for storing only a fraction of the hot expert weights, increasing expert coverage at the same memory cost, as described in more detail in connection with FIGS. 2-3.

FIG. 2 illustrates storage of weights 200 associated with the experts activated most frequently (e.g., hot experts) and the experts activated with moderate frequency (e.g., partial hot experts) of FIG. 1, including expert weight manager circuitry 203 for storage and management of the expert weights in accordance with methods and apparatus disclosed herein. In the example of FIG. 2, the expert weight manager circuitry 203 initiates a full hot expert buffer 205 to store the entire weights of a few dominantly hot experts and initiates a partial hot expert buffer 210 to store only a fraction (f) of weights associated with each moderately hot expert. As such, the expert weight manager circuitry 203 performs caching of 1/f times more experts at the same memory cost. For example, with k=10 and f=0.25, the full hot expert buffer 205 stores k=10 full-weight experts, while the partial hot expert buffer 210 stores k*(1/f)=40 partial-weight experts (e.g., each with 25% of their weights), quadrupling the number of cached experts. In examples disclosed herein, the storage fraction (f) can be fine-tuned based on heuristics such as compute capability and memory bandwidth, optimizing performance across different workloads. By storing partial weights of many experts rather than full weights of a few experts, the partial hot expert buffer 210 significantly increases the cached expert coverage and the likelihood of expert hits. Likewise, the partial hot expert buffer 210 achieves compute-memory overlap by allowing prefetching of non-cached weights during computation of the cached portion, hiding memory transfer latency. As such, the full hot expert buffer 205 and the partial hot expert buffer 210 act as dedicated high-speed buffers (e.g., GPU memory or cache).

In the example of FIG. 2, the expert weight manager circuitry 203 identifies the global hot expert counter 145 of FIG. 1, as described in more detail below. For example, the global hot expert counter 145 identifies the experts associated with the MoE model that are consistently selected to process a disproportionately large share of incoming tokens or data. In the example of FIG. 2, an MoE layer 215 is shown as part of a transformer block 220, with the MoE representing a neural network architecture that replaces traditional dense feed-forward (FNN) layers with sparse MoE layers. The sparse MoE layers have a predefined number of experts (e.g., simple FFNs, nested MoEs, etc.), each representing a neural network handling different aspects or subsets of the input data. The MoE also includes a gating network or router that determines which tokens are sent and identifies experts for receiving the tokens. For example, the gating network (e.g., router(s) 225, 230) analyzes input data to determine which expert(s) are best suited to process the data by assigning a weight (e.g., an importance score) to each expert based on the characteristics of the input tokens. Experts with the highest weights are subsequently selected to process the input. In some examples, the gating network performs Top-K routing by selecting the top k experts with the highest affinity scores. For example, the router(s) 225, 230 process input token(s) 235, 240 (e.g., sequential token(s) x₁=“more” and x₂= “parameters”) prior to the routing (solid line) of the token(s) across four FFN experts (e.g., FFN1, FFN2, FFN3, FFN4), such that the router(s) 225, 230 independently route each token, with a switch FFN layer returning the output of the selected FFN (e.g., FFN1, FFN2, etc.) multiplied by a router gate value (e.g., probabilities p=0.65, =0.8, shown with a dotted line, where the router gate value p indicates that the router has assigned a probability or weight of 0.8 to a specific expert, indicating that the router considers a given expert highly relevant and likely to provide the most accurate output).

In the example of FIG. 2, the MoE layer 215 selection of experts is identified with respect to the global hot expert counter 145, which identifies experts selected to process a disproportionately large share of the incoming tokens (e.g., token(s) 235, 240), where rows 115 represent the layer numbers and columns 120 represent the expert indices. In the example of FIG. 2, the MoE layer 215 corresponds to the fifteenth layer, where a second expert in the fifteenth layer is selected a total of thirty-three times (e.g., representing a hot expert) and a sixth expert in the fifteenth layer is selected a total of twenty-two times (e.g., representing a moderately hot expert). In examples disclosed herein, the expert weight manager circuitry 203 initiates dominantly hot expert storage 245, 250 (e.g., using full weights of the dominantly hot experts) in the full hot expert buffer 205 and initiates moderately hot expert storage 255, 260 (e.g., using partial weights of the moderately hot experts) in the partial hot expert buffer 210. While in the example of FIG. 2 the model used (e.g., Mixtral-8x7B) includes a total of eight experts per layer (e.g., experts 0-7 and layers 1-32), where two experts are selected per layer, any other expert number per layer can be used during identification and/or storage of the full weights and/or the partial weights of the experts (e.g., selection of two experts per layer).

In some examples, the expert weight manager circuitry 203 can keep all non-expert weights in GPU memory without switching the weights out, given that the non-expert weights typically occupy only a small portion of the total memory. Given the Mixtral-8x7B model described in connection with FIG. 1, memory usage for inference on AI PCs and consumer GPUs under mixed precision can be summarized as shown below in Table 1:

TABLE 1

| Component | Precision | Size (Approx.) | |
|---|---|---|---|
| Embeddings | 16-bit | ~1 | GB |
| Attention Layers | 4-bit | ~0.75 | GB |
| Active Experts | 4-bit | ~7 | GB |
| Inactive Experts | 4-bit | ~21 | GB |
| Router | 16-bit | ~0.2 | GB |
| Layer Normalization | 16-bit | ~0.2 | GB |
| Output Projection | 16-bit | ~1 | GB |
| Total Size | Mixed | 30.15 | GB |

As such, global memory available on AI PCs and consumer GPUs can be sufficient to keep all non-expert weights (e.g., embeddings, attention layers, active experts, router, layer normalization, and output projection weights in GPU memory), while inactive experts are offloaded to slower memory (e.g., CPU or disk). This approach ensures efficient resource allocation while maintaining quick access to these weights during computation on resource-constrained devices (e.g., AI PCs and consumer GPUs). Additionally, the expert weight manager circuitry 203 tracks global expert usage and stores the K hottest expert weights in dedicated high-speed buffers. To optimize performance, the expert weight manager circuitry 203 increments the counters for selected experts (e.g., experts selected by the router(s) 225, 230) in the global hot expert counter at each expert selection step (e.g., for each token in each layer) during the inference decode phase and/or during the prefill phase. For example, after processing all layers for each token, if the expert weight manager circuitry 203 determines that the expert usage distribution changes significantly, the expert weight manager circuitry 203 performs a Top-K selection on the global hot expert counter to update the hot expert buffer, which stores the K most frequently used experts, replacing only those that have fallen out of the Top-K selection. This ensures the accumulation of global expert usage statistics across all layers while reducing unnecessary updates, particularly in early stages before the distribution stabilizes. By continuously maintaining the K hottest experts in dedicated high-speed memory at any given time, the expert weight manager circuitry 203 improves the expert hit rate and reduces memory transfer overhead.

FIG. 3 illustrates an example algorithm 300 for the storage and management of expert weights performed using the expert weight manager circuitry 203 of FIG. 2, including loading of weights into memory and decoding. In the example of FIG. 3, the expert weight manager circuitry 203 performs initialization 305 to initialize the global hot expert counter 145 (e.g., based on the number of experts corresponding to the number of experts per layer multiplied by the total number of layers), and sets the partial hot experts, the full hot experts, the full hot expert buffer, and the partial hot expert buffer to null. Subsequently, the expert weight manager circuitry 203 loads common non-expert weights into memory (e.g., weight loading 310). For example, for each MoE layer, the expert weight manager circuitry 203 loads embedding weights, query (Q), key (K), and value (V) weights, creates a Key-Value (KV) buffer, and loads a Language Model (LM) head weight. In examples disclosed herein, the LM head represents a final layer in a language model that maps hidden states from the transformer to token probabilities, generating the final output of the language model. In examples disclosed herein, the full hot expert buffer and the partial hot expert buffer information remains in the memory, while the weights loaded into memory can be switched in and out of the dedicated high-speed memory.

The expert weight manager circuitry 203 proceeds to initiate a decoding phase 315 for each token (e.g., token(s) 235, 240) and/or layer. For example, the expert weight manager circuitry 203 performs a query (Q), key (K), and value (V) General Matrix Multiply (GEMM) calculation, saves current Q, K, and V to the KV buffer, calculates attention, performs routing to obtain selected experts (e.g., experts selected by the router(s) 225, 230), and tracks the number of selected experts activated using the global hot expert counter 145. In the example of FIG. 3, the expert weight manager circuitry 203 directly computes the LM head (e.g., full cache hit LM head computation 320) when there is a full cache hit (e.g., selected experts are identified in the full hot expert buffer 205). As such, if the selected experts are already in the full hot expert buffer 205, the expert weight manager circuitry 203 performs a direct computation (e.g., given that hot experts already reside in GPU memory), since otherwise the weights would need to be loaded into GPU memory before proceeding with the computation.

Additionally, the expert weight manager circuitry 203 computes a partial LM head (e.g., partial cache hit LM head computation 325) for an available chunked GEMM by first identifying the presence of selected experts in the partial hot expert buffer 210 (e.g., representing a partial cache hit), then pre-fetching non-cached chunks asynchronously, and computing the partial LM head for an available chunk while any non-cached chunks remain. In examples disclosed herein, the expert weight manager circuitry 203 divides an expert GEMM into column-wise chunks for an expert in the partial hot expert buffer 210 (e.g., where an f % of the weight is cached). Additionally, n columns are divided into 1/f contiguous chunks, each of size n×f (e.g., n=1024 and f=0.25, with 4 chunks of 256 columns). As such, the original expert GEMM operation (e.g., C=A@weight) is now performed in chunks, such that for i ranging from 0 to (1/f)−1, C[:, i×(n×f):(i+1)×(n×f)]=A@Weight[:, i×(n×f):(i+1)×(n×f)].

For example, non-cached chunks begin prefetching immediately, and computation proceeds as first-available, first-compute. Since each chunked GEMM is independent, the expert weight manager circuitry 203 processes each chunk as soon as their weights are ready, increasing overlap between computation and memory transfer of non-cached chunks. In the example of FIG. 3, the expert weight manager circuitry 203 proceeds to load the full expert weights of selected experts before computing the LM head (e.g., no cache hit LM head computation 330) when there is no cache hit (e.g., selected experts are not present in the full hot expert buffer or the partial hot expert buffer). The compute time is longer for the no cache hit LM head computation 330 as compared to the full cache hit LM head computation 320 and/or the partial cache hit LM head computation 325, since there is a need to load the entire weights for the no cache hit LM head computation 330.

In the example of FIG. 3, the expert weight manager circuitry 203 also performs an update of the hot expert buffers based on usage (e.g., buffer update 335). For example, the expert weight manager circuitry 203 uses the global hot expert counter 145 to track the total number of times a particular expert is activated. When the expert weight manager circuitry 203 determines that the change in the counter exceeds a threshold over time (e.g., global hot expert counter compared to a pre global hot expert counter), the expert weight manager circuitry 203 identifies the full hot experts as the Top-K experts from the global hot expert counter 145 and the partial hot experts as the next Top-K*(1/f) experts from the global hot expert counter 145. The expert weight manager circuitry 203 then proceeds to update the full hot experts buffer 205 with the identified full hot experts and the partial hot experts buffer 210 with the identified partial hot experts.

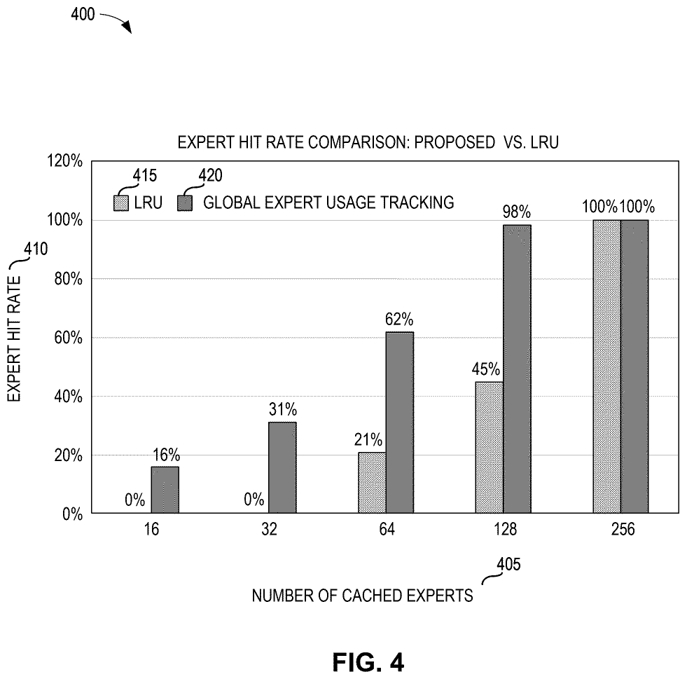

FIG. 4 illustrates an example comparison 400 of expert hit rates using known caching techniques (e.g., Least Recently Used (LRU) caching 415) and the global expert usage tracking 420 disclosed herein. LRU caching 415 stores data in a way that prioritizes recently accessed items, such that when the cache is full, the least recently used item is discarded to allow for storage of new data. In the example of FIG. 4, an expert hit rate 410 is shown in connection with a number of cached experts 405 for both the LRU caching 415 and global expert usage tracking 420. Using real Mixtral 8x7B expert activation data (e.g., total 256 experts, 60,000 expert activations), the evaluating against LRU caching 415 shows that the global expert usage tracking 420 disclosed herein significantly improves expert hit rates. The number of cached experts 405 varies, including small cache sizes (e.g., 16-32 experts), medium-cache sizes (e.g., 64-128 experts), and full capacity (e.g., 256 experts).

For example, classical caching methods (e.g., Least Recently Used (LRU), Least Frequently Used (LFU), Last-In, First-Out (LIFO), First-In, First-Out (FIFO)) track only experts currently cached, losing track upon eviction, whereas the global expert usage tracking 420 (e.g., via L×N global expert counter) maintains holistic usage patterns, caching the most globally frequent experts and significantly increasing the expert hit rate. Medium cache sizes associated with global expert usage tracking 420 include 64 experts corresponding to 32 experts stored in the full hot expert buffer 205 and 32 experts stored in the partial hot expert buffer 210, and 128 experts corresponding to 64 experts stored in each of the buffers 205, 210. The dual-buffer design disclosed herein provides additional gains by storing fractional weights of many, moderately frequent experts. For example, alongside the full hot expert buffer 205, the partial hot expert buffer 210 significantly increases the cached expert coverage at the same memory cost, increasing the likelihood of a cache hit. When compared at full capacity (e.g., 256 experts), both the LRU caching 415 and the global expert usage tracking 420 achieves a 100% hit rate, which represents a theoretical upper bound that is not possible in practice due to GPU memory constraints.

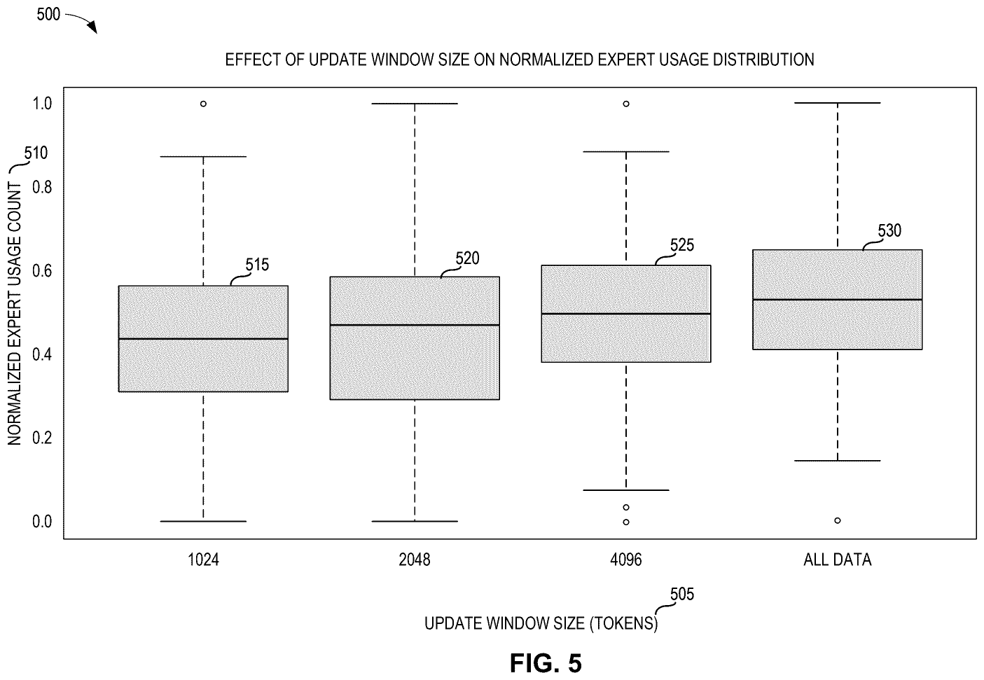

FIG. 5 illustrates example distribution 500 of expert usage counts based on update intervals, indicating effects of reset frequencies on expert usage distribution. For example, normalized expert usage count(s) 510 are shown for a given update window size (e.g., tokens) 505, comparing different update intervals (e.g., 1024, 2048, 4096 tokens, and continuous accumulation), indicating similar expert usage distributions regardless of window size. As such, the update window size can be freely adjusted without affecting hot expert selection behavior. For example, the selection of hot experts is based on the expert usage counter, whose update timing can be evaluated using real expert activation patterns from Mixtral 8x7B (1,000 input/output sequence lengths with a total of 60,000 expert activations). In examples disclosed herein, the distribution of expert usage counts remains stable regardless of the update intervals (e.g., window sizes), demonstrating that the reset frequency, or continuous accumulation, has a small impact on expert usage distribution.

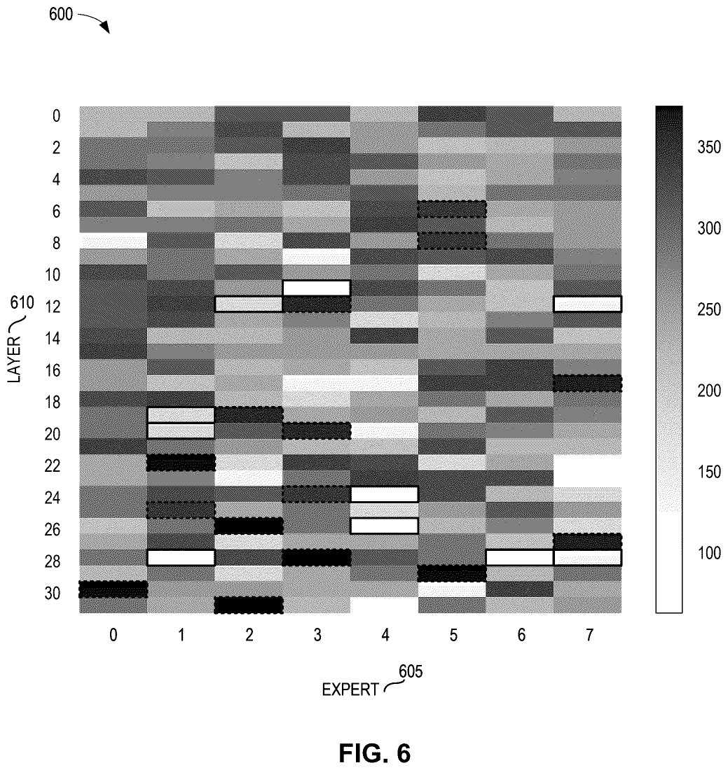

FIG. 6 represents an example heatmap 600 illustrating an imbalance of expert usage based on identification of frequently activated experts and rarely used experts, where expert(s) 605 are assessed at various layer(s) 610. For example, numerous studies have shown that in real-world MoE inference, expert usage is highly imbalanced, with some experts activated often while others are rarely used. For example, the heatmap 600 visualizes known heavy-hitters counting statistics on a Mixtral Massive Multitask Language Understanding (MMLU) benchmark, illustrating this pattern of expert usage imbalance and highlighting frequently activated experts (e.g., outlined in dotted black line(s)) and rarely used experts (e.g., outlined using solid black line(s)). Such an imbalance emphasizes the need for efficient weight management in MoE models, particularly for small batch sizes (e.g., batch size=1). Methods and apparatus disclosed herein introduce efficient weight management to cache not only the most frequent experts but also a broad set of moderately frequent experts at the same memory cost, reducing the need for frequent memory access.

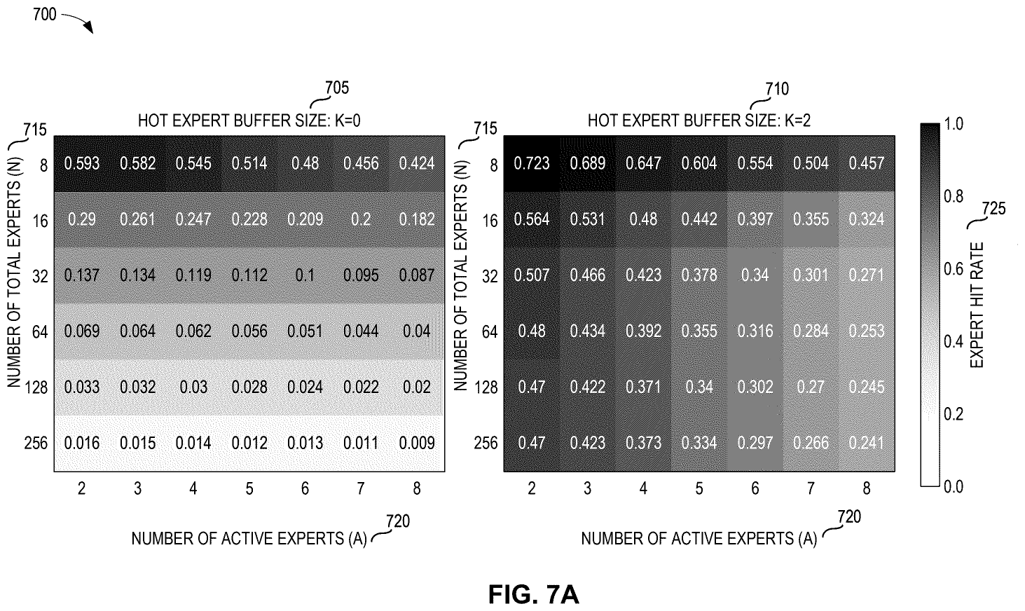

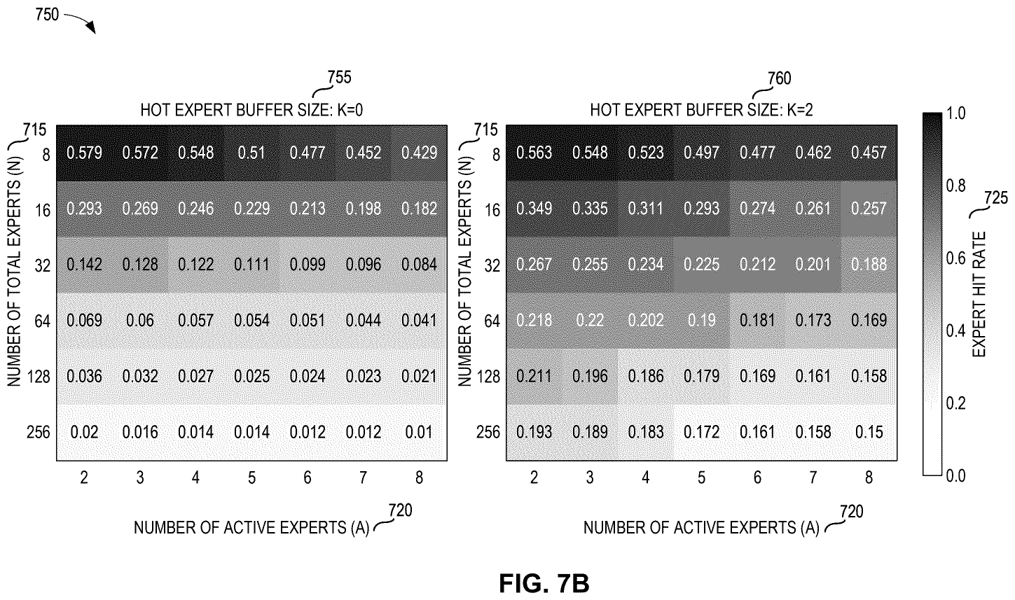

FIG. 7A illustrates an increase in expert hit rates 700 using methods and apparatus disclosed herein for a total probability of selecting k hot experts set at β=0.5. In the example of FIG. 7A, results for a first hot expert buffer size 705 (e.g., buffer size of k=0, indicating the lack of a hot expert buffer) are compared to results for a second hot expert buffer size 710 (e.g., buffer size of k=2), with an indication of a number of total experts 715 and a number of active experts 720, including an expert hit rate 725. Likewise, FIG. 7B illustrates an increase in expert hit rates 750 using methods and apparatus disclosed herein for a total probability of selecting k hot experts set at β=0.2.

FIGS. 7A and 7B show results obtained with a simulated MoE inference system with n total experts, selecting a active experts per iteration. A GPU memory of size g stores (g-k) experts, while the full hot expert buffer 205 holds k hot experts that are selected with higher probability (β/k), while non-hot experts are selected with lower probability ((1−β)/(n−k)). The inference simulation system ensures k<a, g<n, such that the number of hot experts is smaller than both the number of active experts and the GPU memory size, which in turn are smaller than the total number of experts. The simulation compares the expert hit rates across different values of n and a, comparing k=0 (no buffer) versus k=2 (buffer with 2 hot experts). For example, n=256 and a=8 models MoE in DeepSeek-V3, while n=8 and a=2 models MoE in Mixtral 8x7B.

In the example of FIGS. 7A and 7B, the full hot expert buffer 205 significantly improves the expert hit rate(s) 700, 750. This advantage becomes more pronounced as the total number of experts (n) increases, the number of active experts (a) increases, and the total probability of selecting k hot experts (β) increases. When comparing k=0 (no buffer) and k=2 (a buffer with 2 hot experts), the expert hit rate improves substantially, highlighting the effectiveness of keeping frequently used experts in a dedicated buffer. For example, when n=256 and a=8, the expert hit rate increases from 0.9% to 24.1% at β=0.5 with the full hot expert buffer 205 (e.g., as shown in FIG. 7A). For example, as n increases, the expert selection pool grows, making selection more dispersed. The full hot expert buffer 205 counteracts this by prioritizing frequently used experts, increasing the expert hit rate. Additionally, with a larger a, more experts are selected per token, increasing the chances of hitting those stored in the buffer. Similarly, at β=0.2, when n=256 and a=8, the expert hit rate increases from 1% to 15% with the full hot expert buffer (e.g., as shown in FIG. 7B), demonstrating significant improvement even as the probability of selecting hot experts decreases.

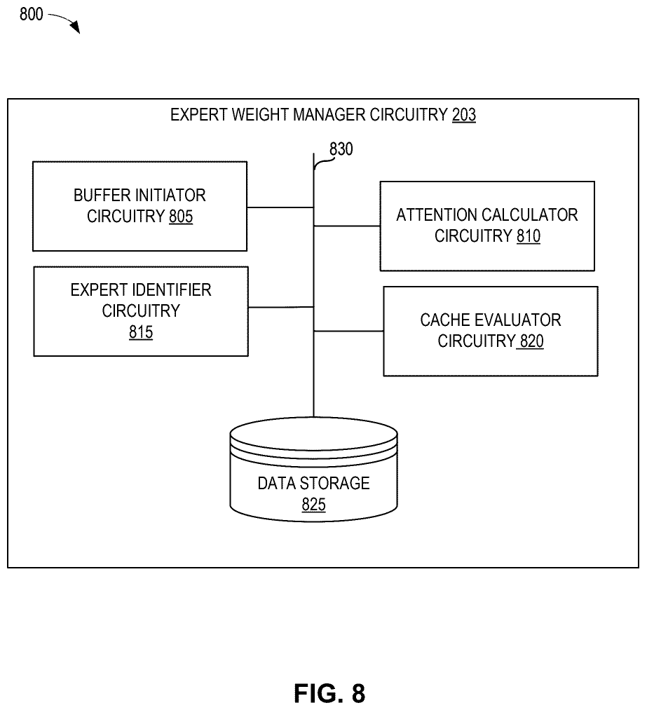

FIG. 8 is a block diagram 800 of an example known implementation of the expert weight manager circuitry 203 of FIG. 2 constructed in accordance with teachings of this disclosure for MoE inference with full and partial hot expert buffers. The expert weight manager circuitry 203 of FIG. 2 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the expert weight manager circuitry 203 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

In the example of FIG. 8, the expert weight manager circuitry 203 includes example buffer initiator circuitry 805, example attention calculator circuitry 810, example expert identifier circuitry 815, example cache evaluator circuitry 820, and example data storage 825. The buffer initiator circuitry 805, attention calculator circuitry 810, expert identifier circuitry 815, cache evaluator circuitry 820, and data storage 825 are in communication via an example bus 830.

The buffer initiator circuitry 805 initiates the full hot expert buffer and the partial hot expert buffer (e.g., full hot expert buffer 205, partial hot expert buffer 210 of FIG. 2). For example, the buffer initiator circuitry 805 initiates the full hot expert buffer to store (e.g., in dedicated high-speed memory) entire weights of the most frequently used experts and initiates the partial hot expert buffer to store a fraction of the weights for moderately used experts. As described in connection with FIG. 1, given k=10 experts and f=0.25 as a fraction of weights, the buffer initiator circuitry 805 can initiate storage of k=10 full-weight experts, while storing k*(1/f)=40 partial-weight experts. In some examples, the buffer initiator circuitry 805 determines the full-weight experts to store and/or the partial-weight experts to store based on compute capability and/or memory bandwidth. For example, storage of the partial weights of many experts significantly increases cached expert coverage and probability of expert hits. In examples disclosed herein, the buffer initiator circuitry 805 retains the full hot expert buffer 205 and the partial hot expert buffer 210 in the GPU memory.

In examples disclosed herein, the buffer initiator circuitry 805 updates full and partial hot expert buffers based on usage. For example, the buffer initiator circuitry 805 tracks the global hot expert counter (e.g., global hot expert counter 145 of FIG. 1) to identify a total number of times a particular expert is activated. The buffer initiator circuitry 805 compares expert activations in a pre-global hot expert counter with expert activations in the global hot expert counter to determine a change in the expert counts over time. When the buffer initiator circuitry 805 determines that a set threshold has been exceeded, the buffer initiator circuitry 805 updates the full hot expert buffer with the identified full hot experts (e.g., Top-K experts from the global hot expert counter 145) and the partial hot expert buffer with the identified partial hot experts (e.g., next Top-K*(1/f) experts).

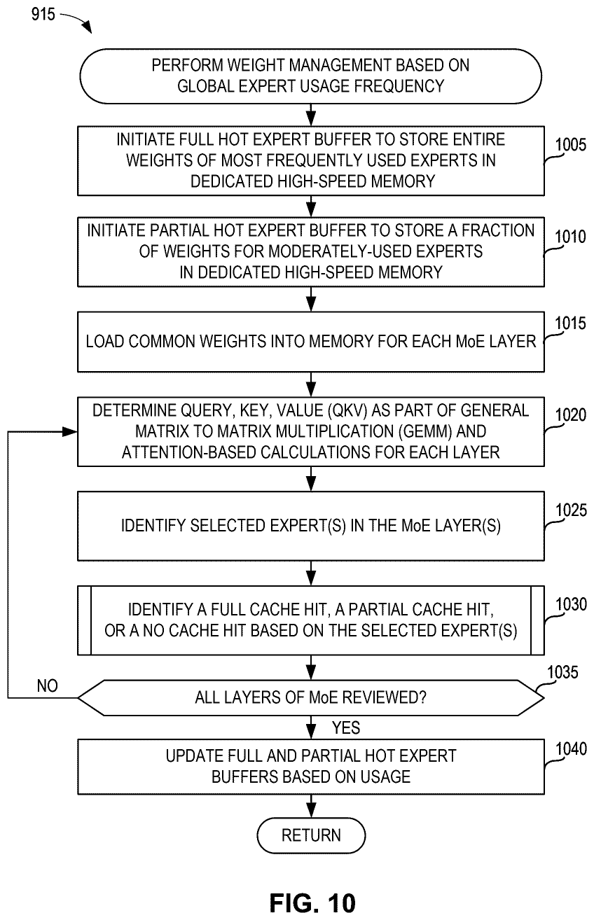

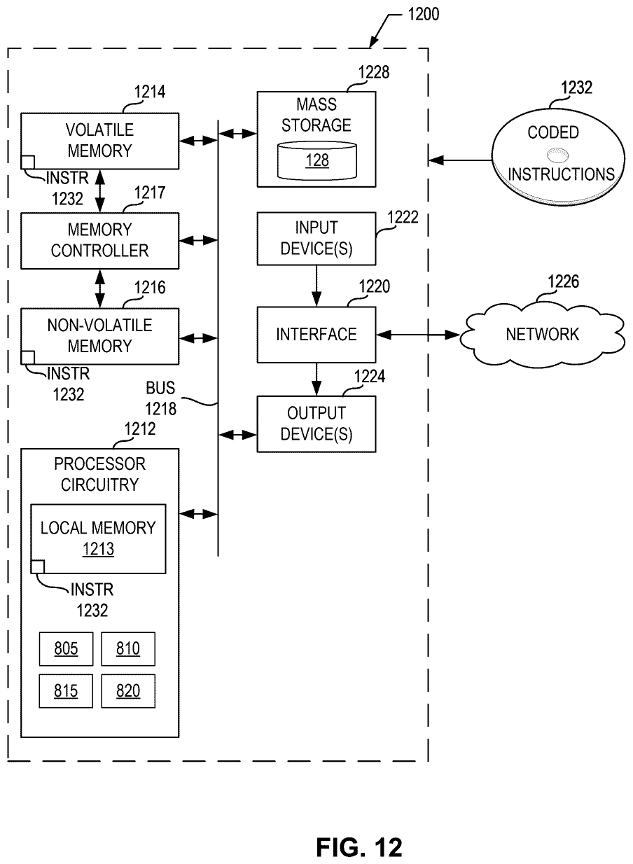

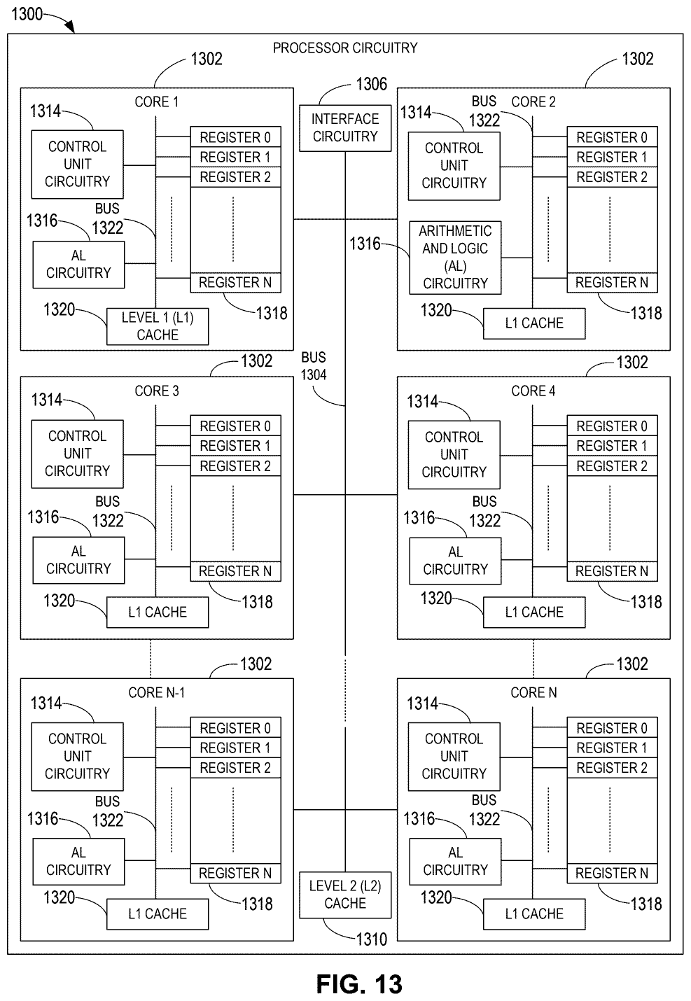

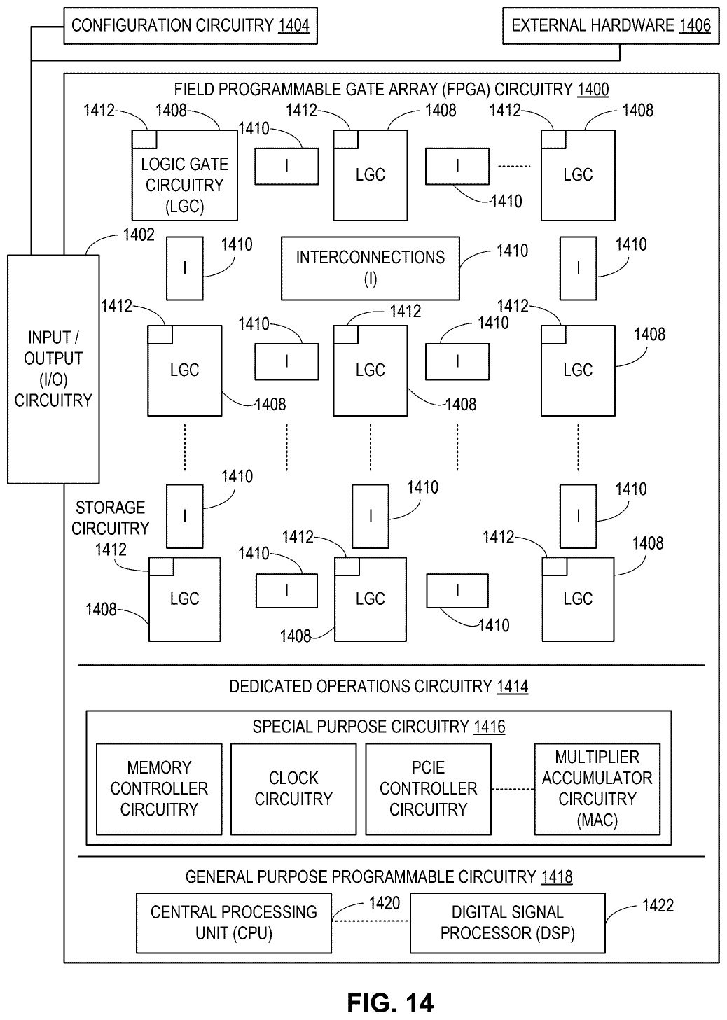

In some examples, the apparatus includes means for initializing a buffer. For example, the means for initializing a buffer may be implemented by buffer initiator circuitry 805. In some examples, the buffer initiator circuitry 805 may be instantiated by programmable circuitry such as the example programmable circuitry 1212 of FIG. 12. For instance, the buffer initiator circuitry 805 may be instantiated by the example microprocessor 1300 of FIG. 13 executing machine executable instructions such as those implemented by at least block(s) 1005, 1010 of FIG. 10. In some examples, the buffer initiator circuitry 805 may be instantiated by hardware logic circuitry, which may be implemented by an ASIC, XPU, or the FPGA circuitry 1400 of FIG. 14 structured to perform operations corresponding to the machine readable instructions. Additionally or alternatively, the buffer initiator circuitry 805 may be instantiated by any other combination of hardware, software, and/or firmware. For example, the buffer initiator circuitry 805 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The attention calculator circuitry 810 performs attention-based calculations for each MoE layer within a transformer architecture (e.g., MoE layer(s) associated with rows 115 of the global hot expert counter 145 of FIG. 1), as described in more detail in connection with FIG. 2. For example, the attention calculator circuitry 810 loads common weights into memory for each MoE layer, such that weights loaded into memory can be switched in and out of the dedicated high-speed memory. In examples disclosed herein, the attention calculator circuitry 810 performs calculations that identify an expert that can be best suited for processing each input token (e.g., token(s) 235, 240 of FIG. 2), allowing for the dynamic routing (e.g., using router(s) 225, 230 of FIG. 2) of the input to the most relevant experts. For example, the attention calculator circuitry 810 loads query (Q), key (K), and value (V) weights, creates a Key-Value (KV) buffer, and loads a Language Model (LM) head weight, as described in connection with FIG. 3. In examples disclosed herein, the attention calculator circuitry 810 performs Q, K, V GEMM-based calculations, initiates routing to identify the selected experts, and track the number of selected experts (e.g., using global hot expert counter 145).

In some examples, the apparatus includes means for computing attention. For example, the means for computing attention may be implemented by attention calculator circuitry 810. In some examples, the attention calculator circuitry 810 may be instantiated by programmable circuitry such as the example programmable circuitry 1212 of FIG. 12. For instance, the attention calculator circuitry 810 may be instantiated by the example microprocessor 1300 of FIG. 13 executing machine executable instructions such as those implemented by at least block(s) 1020 of FIG. 10. In some examples, the attention calculator circuitry 810 may be instantiated by hardware logic circuitry, which may be implemented by an ASIC, XPU, or the FPGA circuitry 1400 of FIG. 14 structured to perform operations corresponding to the machine readable instructions. Additionally or alternatively, the attention calculator circuitry 810 may be instantiated by any other combination of hardware, software, and/or firmware. For example, the attention calculator circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The expert identifier circuitry 815 identifies selected experts in the MoE layer(s). For example, as the attention calculator circuitry 810 performs attention-based calculations, the expert identifier circuitry 815 tracks the experts selected as part of routing-based operations (e.g., including analysis of input data to determine which expert(s) are best suited to process the data by assigning a weight to each expert based on the characteristics of the input tokens). In some examples, the expert identifier circuitry 815 identifies the selected experts based on gating network operations that perform Top-K routing by selecting the top k experts with the highest affinity scores, as described in connection with FIG. 2. In examples disclosed herein, the expert identifier circuitry 815 increments the counters for selected experts in the global hot expert counter at each expert selection step (e.g., for each token in each layer) during the inference decode phase initiated by the attention calculator circuitry 810.

In some examples, the apparatus includes means for identifying a selected expert. For example, the means for identifying a selected expert may be implemented by expert identifier circuitry 815. In some examples, the expert identifier circuitry 815 may be instantiated by programmable circuitry such as the example programmable circuitry 1212 of FIG. 12. For instance, the expert identifier circuitry 815 may be instantiated by the example microprocessor 1300 of FIG. 13 executing machine executable instructions such as those implemented by at least block(s) 1020 of FIG. 10. In some examples, the expert identifier circuitry 815 may be instantiated by hardware logic circuitry, which may be implemented by an ASIC, XPU, or the FPGA circuitry 1400 of FIG. 14 structured to perform operations corresponding to the machine readable instructions. Additionally or alternatively, the expert identifier circuitry 815 may be instantiated by any other combination of hardware, software, and/or firmware. For example, the expert identifier circuitry 815 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The cache evaluator circuitry 820 identifies a full cache hit, a partial cache hit, or a no cache hit based on the selected expert(s) identified by the expert identifier circuitry 815. For example, the cache evaluator circuitry 820 directly computes a language model (LM) head or performs a partially direct computation of the LM head depending on the identification of a full cache hit or a partial cache hit, respectively. Conversely, the cache evaluation circuitry 820 loads full weights to perform the LM head calculation when a no cache hit is identified. As described in connection with FIG. 3, the full cache hit corresponds to the cache evaluator circuitry 820 determining that the selected experts have entire weights stored in the full hot expert buffer 205, a partial cache hit corresponds to the cache evaluator circuitry 820 determining that the selected experts have partial weights stored in the partial hot expert buffer 210, and the no cache hit corresponds to the cache evaluator circuitry 820 determining that the selected experts do not have weights stored in the full hot expert buffer 205 or the partial hot expert buffer 210. For example, the cache evaluator circuitry 820 proceeds with a direct computation of the LM head given that the selected experts already reside in GPU memory, as otherwise the weights need to be loaded into GPU memory before proceeding with the computation.

In examples disclosed herein, the cache evaluator circuitry 820 performs a partially direct computation of the LM head for an available chunked GEMM based on the presence of selected experts in the partial hot expert buffer 210. For example, the cache evaluator circuitry 820 pre-fetches all non-cached chunks asynchronously while computing the partial LM head for the available chunk(s). As described in more detail in connection with FIG. 3, the cache evaluator circuitry 820 divides an expert GEMM into column-based chunks, with the column-based chunks divided into 1/f contiguous chunks, each of size n×f. Given the use of independent chunked GEMMs, the cache evaluator circuitry 820 processes each chunk as soon as the weights are ready, increasing the overlap between computation and memory transfer of non-cached chunks.

In some examples, the apparatus includes means for computing an LM head. For example, the means for computing an LM head may be implemented by cache evaluator circuitry 820. In some examples, the cache evaluator circuitry 820 may be instantiated by programmable circuitry such as the example programmable circuitry 1212 of FIG. 12. For instance, the cache evaluator circuitry 820 may be instantiated by the example microprocessor 1300 of FIG. 13 executing machine executable instructions such as those implemented by at least block(s) 1030 of FIG. 10. In some examples, the cache evaluator circuitry 820 may be instantiated by hardware logic circuitry, which may be implemented by an ASIC, XPU, or the FPGA circuitry 1400 of FIG. 14 structured to perform operations corresponding to the machine readable instructions. Additionally or alternatively, the cache evaluator circuitry 820 may be instantiated by any other combination of hardware, software, and/or firmware. For example, the cache evaluator circuitry 820 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 825 can be used to store any information associated with the buffer initiator circuitry 805, the attention calculator circuitry 810, the expert identifier circuitry 815, and/or the cache evaluator circuitry 820. The data storage 825 of the illustrated example of FIG. 8 can be implemented by any memory, storage device and/or storage disc for storing data such as flash memory, magnetic media, optical media, etc. Furthermore, the data stored in the data storage 825 can be in any data format such as binary data, comma delimited data, tab delimited data, structured query language (SQL) structures, image data, etc.

While an example manner of implementing the expert weight manager circuitry 203 is illustrated in FIG. 8, one or more of the elements, processes and/or devices illustrated in FIG. 8 may be combined, divided, re-arranged, omitted, eliminated and/or implemented in any other way. Further, the example buffer initiator circuitry 805, the example attention calculator circuitry 810, the example expert identifier circuitry 815, the example cache evaluator circuitry 820 and/or, more generally, the example expert weight manager circuitry 203 of FIG. 2 may be implemented by hardware, software, firmware and/or any combination of hardware, software and/or firmware. Thus, for example, any of the buffer initiator circuitry 805, the attention calculator circuitry 810, the expert identifier circuitry 815, the cache evaluator circuitry 820 and/or, more generally, the expert weight manager circuitry 203 of FIG. 2 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the expert weight manager circuitry 203 of FIG. 2 may include one or more elements, processes, and/or devices in addition to, or instead of, those illustrated in FIG. 8, and/or may include more than one of any or all of the illustrated elements, processes and devices.

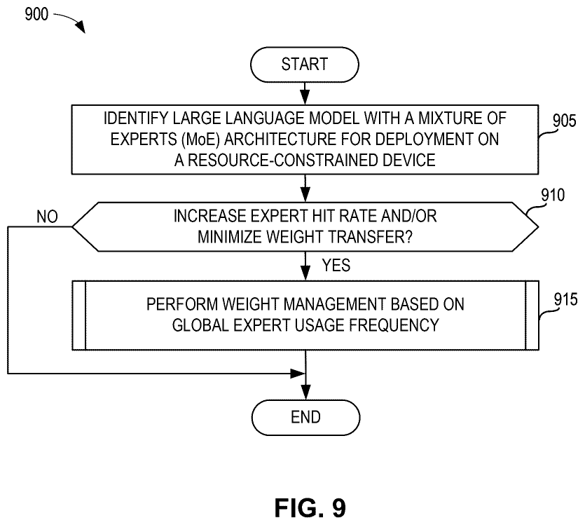

Flowcharts representative of example machine readable instructions, which may be executed by programmable circuitry to implement and/or instantiate the task manager circuitry 301 of FIG. 3 and/or representative of example operations which may be performed by programmable circuitry to implement and/or instantiate the expert weight manager circuitry 203 of FIG. 2, are shown in FIGS. 9-11. The machine readable instructions may be one or more executable programs or portion(s) of one or more executable programs for execution by programmable circuitry, such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 9-11, many other methods of implementing the expert weight manager circuitry 203 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 9-11 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by example programmable circuitry to implement the expert weight manager circuitry 203 of FIG. 2. The machine-readable instructions and/or the operations 900 of FIG. 9 begin at block 905, at which the buffer initiator circuitry 805 identifies a Large Language Model (LLM) with a Mixture of Experts (MoE) architecture for deployment on a resource-constrained device (e.g., AI PC, consumer GPU, etc.). For example, if the buffer initiator circuitry 805 determines that an increase in the expert hit rate can be achieved and/or weight transfers between Central Processing Unit (CPU) and Graphics Processing Unit (GPU) memories can be reduced, at block 910, the buffer initiator circuitry 805 initiates weight management based on global expert usage frequency to increase expert hit rates and reduce weight transfer, at block 915.

For example, as described in more detail in connection with FIG. 10, the expert weight manager circuitry 203 improves GPU-to-CPU memory transfers as well as cache-to-global and CPU-to-disk memory transfers through the use of full hot expert buffers and partial hot expert buffers, making MoE models more efficient and practical for resource-constrained devices (e.g., AI PCs, consumer GPUs, etc.). In examples disclosed herein, the expert weight manager circuitry 203 identifies a full cache hit, a partial cache hit, or a no cache hit based on expert(s) selected as part of a transformer network-based attention calculation performed to match input token(s) with relevant experts for processing. When expert weight manager circuitry 203 identifies the selected expert(s) in the full hot expert buffer 205 or the partial hot expert buffer 210, the expert weight manager circuitry 203 performs a direct computation (e.g., directly computing a language model head) or a partially direct computation (e.g., computing a portion of the language model head using cached weights while asynchronously prefetching non-cached weights) as part of the decode phase of inference.

FIG. 10 is a flowchart representative of example machine-readable instructions and/or example operations 915 that may be executed, instantiated, and/or performed by example programmable circuitry to implement the expert weight manager circuitry 203 of FIG. 2 to perform weight management based on global expert usage frequency. The machine-readable instructions and/or the operations 915 of FIG. 9 begin at block 1005, at which the buffer initiator circuitry 805 initiates a full hot expert buffer (e.g., full hot expert buffer 205 of FIG. 2) to store entire weights of most frequently used experts in dedicated high-speed memory. In examples disclosed herein, the buffer initiator circuitry 805 also initiates a partial hot expert buffer to store a fraction of weights for moderately used experts, at block 1010. Once the buffer(s) 205, 210 are initiated, the attention calculator circuitry 810 loads common non-expert weights into memory for each MoE layer, at block 1015. As described in connection with FIG. 3, the attention calculator circuitry 810 also determines Query (Q), Key (K), and Value (V) weights as part of General Matrix Multiply (GEMM) calculations and attention-based calculations for each MoE layer, at block 1020. For example, the attention calculator circuitry 810 Q, K, V GEMM-based calculations, initiates routing to identify the selected experts, and tracks the number of selected experts (e.g., using the global hot expert counter 145 of FIG. 1). Subsequently, the expert identifier circuitry 815 identifies selected experts in the MoE layer(s), at block 1025.

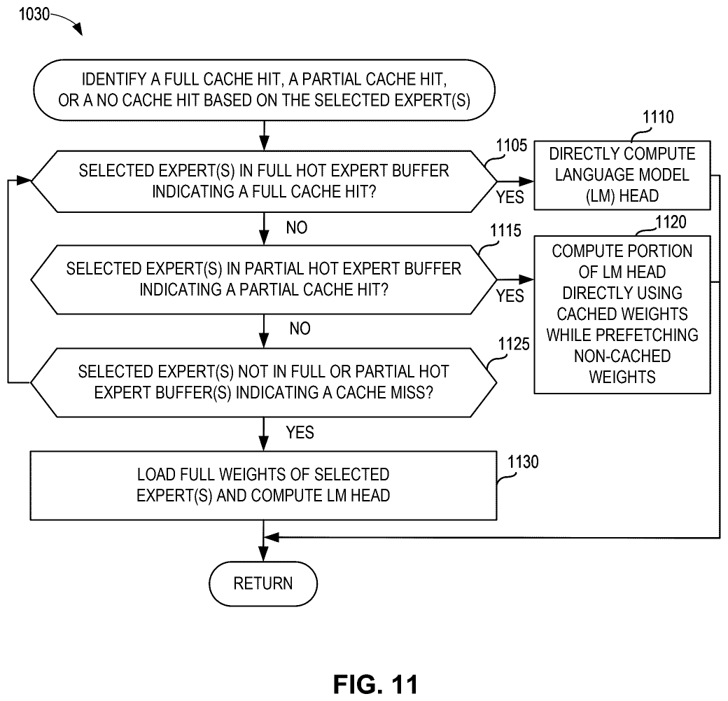

For example, the expert identifier circuitry 815 tracks experts selected as part of routing-based operations and increments the counter(s) for selected experts in the global hot expert counter 145 at each expert selection step, as described in connection with FIG. 3. The cache evaluator circuitry 820 proceeds to identify a full cache hit, a partial cache hit, or a no cache hit based on the selected expert(s), at block 1030. As described in connection with FIG. 11, the cache evaluator circuitry 820 determines whether the selected experts match experts in the full hot expert buffer 205 or in the partial hot expert buffer 210 to determine whether to perform a direct computation of a Language Model (LM) head or a partially direct computation of the LM head. Once the attention calculator circuitry 810 determines that all layers of the MoE have been reviewed, at block 1035, the buffer initiator circuitry 805 updates the full and partial hot expert buffers based on usage, at block 1040. For example, as described in connection with FIG. 3, the buffer initiator circuitry 805 compares expert activations in a pre-global hot expert counter with expert activations in the global hot expert counter to determine a change in expert counts over time. In some examples, the buffer initiator circuitry 805 updates the full hot expert buffer 205 with identified full hot experts (e.g., Top-K experts) and the partial hot expert buffer 210 with identified partial hot experts (e.g., next Top-K*(1/f) experts) when a set threshold has been exceeded in connection with the expert counts changes between the pre-global hot expert counter and the global hot expert counter.

FIG. 11 is a flowchart representative of example machine-readable instructions and/or example operations 1030 that may be executed, instantiated, and/or performed by example programmable circuitry to implement the expert weight manager circuitry 203 of FIG. 2 to identify a full cache hit, a partial cache hit, or a no cache hit based on the selected expert(s). The machine-readable instructions and/or the operations 1030 of FIG. 11 begin at block 1105, at which the cache evaluator circuitry 820 determines whether the selected experts match experts in the full hot expert buffer 205, indicating a full cache hit. For a full cache hit, the cache evaluator circuitry 820 directly computes the LM head, at block 1110. For example, during the direct computation (e.g., full cache hit), no memory transfers occur, and computation starts immediately, since the entire expert weight is fully cached in the full hot expert buffer 205. Alternatively, if the cache evaluator circuitry 820 determines that the selected expert(s) match experts in the partial hot expert buffer 210, indicating a partial cache hit, at block 1115, the cache evaluator circuitry 820 proceeds to perform a partially direct computation of the LM head using prefetched non-cached chunks (e.g., computing a portion of the LM head directly using cached weights while prefetching non-cached weights), at block 1120. For example, the chunked memory transfers overlap with computation, indicating the expert weight(s) are partially cached. As described in connection with FIG. 3, the cache evaluator circuitry 820 pre-fetches all non-cached chunks asynchronously and computes the partial LM head for the available chunk(s).

If the cache evaluator circuitry 820 does not identify a full cache hit or a partial cache hit, the cache evaluator circuitry 820 determines that the selected experts are not a match for experts in the full hot expert buffer 205 or the partial hot expert buffer 210 (e.g., no cache hit), at block 1125. As such, the cache evaluator circuitry 820 initiates a large (e.g., entire weight), high-latency (e.g., PCIe-bound) memory transfer before computation, since the selected expert is not cached. Accordingly, the cache evaluator circuitry 820 proceeds to load the full weights of selected expert(s) and compute the LM head, at block 1130. As such, methods and apparatus disclosed herein reduce the occurrence of such large memory transfers by caching the most frequent experts as well as a broad set of moderately frequent experts at the same memory cost, reducing the need for frequent SSD access.

FIG. 12 is a block diagram of an example programmable circuitry platform 1200 structured to execute and/or instantiate the example machine-readable instructions and/or the example operations of FIGS. 9-11 to implement the example expert weight manager circuitry 203 of FIG. 2. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs microprocessors, CPUs, GPUs, DSPs, and/or microcontrollers from any desired family or manufacturer. The programmable circuitry 1212 may be implemented by one or more semiconductor based (e.g., silicon based) devices. In this example, the processor circuitry 1212 implements the buffer initiator circuitry 805, the attention calculator circuitry 810, the expert identifier circuitry 815, and the cache evaluator circuitry 820.

The programmable circuitry 1212 of the illustrated example includes a local memory 1213 (e.g., a cache, registers, etc.). The programmable circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1200 of the illustrated example also includes one or more mass storage devices 1228 to store software and/or data. Examples of such mass storage devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1232, which may be implemented by the machine readable instructions of FIGS. 9-11, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 9-11 to effectively instantiate the circuitry of FIG. 8 logic circuits to perform the operations corresponding to those machine readable instructions. In some such examples, the circuitry of FIG. 8 is instantiated by the hardware circuits of the microprocessor 1300 in combination with the instructions. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 9-11.

The cores 1302 may communicate by a first example bus 1304. In some examples, the first bus 1304 may implement a communication bus to effectuate communication associated with one(s) of the cores 1302. For example, the first bus 1304 may implement at least one of an Inter-Integrated Circuit (I2C) bus, a Serial Peripheral Interface (SPI) bus, a PCI bus, or a PCle bus. Additionally or alternatively, the first bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1400 of FIG. 14 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 9-11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 9-11. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 9-11. As such, the FPGA circuitry 1400 may be configured and/or structured to effectively instantiate some or all of the operations/functions corresponding to the machine readable instructions of the flowcharts of FIGS. 9-11 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 9-11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 9-11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 14. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1402 of FIG. 14 may execute a first portion of the machine readable instructions represented by the flowchart(s) of FIGS. 9-11 to perform first operation(s)/function(s), the FPGA circuitry 1400 of FIG. 14 may be configured and/or structured to perform second operation(s)/function(s) corresponding to a second portion of the machine readable instructions represented by the flowcharts of FIGS. 9-11, and/or an ASIC may be configured and/or structured to perform third operation(s)/function(s) corresponding to a third portion of the machine readable instructions represented by the flowcharts of FIGS. 9-11.

It should be understood that some or all of the circuitry of FIG. 8 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 8 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12 which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

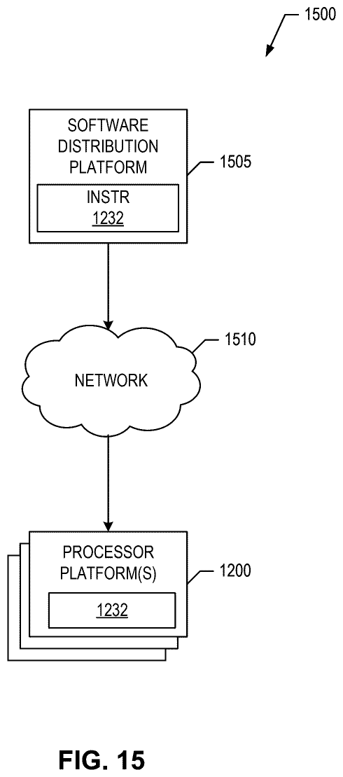

A block diagram illustrating an example software distribution platform 1505 to distribute software such as the example machine readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 1232, which may correspond to the example machine readable instructions of FIGS. 9-11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIGS. 9-11, may be downloaded to the example programmable circuitry platform 1200, which is to execute the machine readable instructions 1232 to implement the expert weight manager circuitry 203 of FIG. 2. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein maintain frequently used experts (e.g., hot experts) in a dedicated buffer to substantially increase the expert hit rate (e.g., a percentage of times the required expert for a given input is identified in the GPU memory or cache), reducing memory transfer overhead. Methods and apparatus disclosed herein introduce a novel weight management technique based on global expert usage frequency to increase expert hit rates and reduce weight transfer. The dual-buffer implementation disclosed herein efficiently caches the full weights of a few dominantly hot experts and the partial weights of many moderately hot experts. Methods and apparatus disclosed herein can be used to achieve lower latency and the ability to run larger models than previously possible on consumer-grade hardware. Thus, examples disclosed herein result in improvements to the operation of a machine.

Example methods, apparatus, systems, and articles of manufacture for Mixture of Experts (MoE) inference with full and partial hot expert buffers are disclosed herein. Further examples and combinations thereof include the following:

Example 1 includes an apparatus, comprising interface circuitry, machine-readable instructions, and at least one processor circuit to be programmed by the machine-readable instructions to initialize a full hot expert buffer to store entire weights of an expert used with a first frequency, initialize a partial hot expert buffer to store partial weights of an expert used with a second frequency, wherein the first frequency is higher than the second frequency, identify a selected expert associated with a Mixture of Experts (MoE) layer of a Large Language Model (LLM), and perform a direct computation or a partially direct computation, the direct computation performed after determination that the selected expert is stored in the full hot expert buffer, the partially direct computation performed after determination that the selected expert is stored in the partial hot expert buffer.

Example 2 includes the apparatus as defined in example 1, wherein one or more of the at least one processor circuit is to perform the partially direct computation by computing a portion of a language model head using cached weights.

Example 3 includes the apparatus as defined in one or more of examples 1-2, wherein one or more of the at least one processor circuit is to asynchronously prefetch non-cached weights when computing the portion of the language model head.

Example 4 includes the apparatus as defined in one or more of examples 1-3, wherein one or more of the at least one processor circuit is to load entire weights of the selected expert before computing a language model head when the selected expert is not stored in the full hot expert buffer or the partial hot expert buffer.

Example 5 includes the apparatus as defined in one or more of examples 1-4, wherein one or more of the at least one processor circuit is to update the full hot expert buffer or the partial hot expert buffer based on an expert usage frequency.

Example 6 includes the apparatus as defined in one or more of examples 1-5, wherein one or more of the at least one processor circuit is to initiate a counter of global expert usage to cache globally frequent experts to increase expert hit rates based on the full hot expert buffer or the partial hot expert buffer.

Example 7 includes the apparatus as defined in one or more of examples 1-6, wherein one or more of the at least one processor circuit is to perform a General Matrix Multiply (GEMM) operation in contiguous chunks for the selected expert in the partial hot expert buffer.

Example 8 includes at least one non-transitory machine-readable medium comprising machine-readable instructions to cause at least one processor circuit to at least initialize a full hot expert buffer to store entire weights of an expert used with a first frequency, initialize a partial hot expert buffer to store partial weights of an expert used with a second frequency, wherein the first frequency is higher than the second frequency, identify a selected expert associated with a Mixture of Experts (MoE) layer of a Large Language Model (LLM), and perform a direct computation or a partially direct computation, the direct computation performed after determination that the selected expert is stored in the full hot expert buffer, the partially direct computation performed after determination that the selected expert is stored in the partial hot expert buffer.

Example 9 includes the at least one non-transitory machine-readable medium as defined in example 8, wherein the machine-readable instructions are to cause one or more of the at least one processor circuit to perform the partially direct computation by computing a portion of a language model head using cached weights.

Example 10 includes the at least one non-transitory machine-readable medium as defined in one or more of examples 8-9, wherein the machine-readable instructions are to cause one or more of the at least one processor circuit to asynchronously prefetch non-cached weights when computing the portion of the language model head.

Example 11 includes the at least one non-transitory machine-readable medium as defined in one or more of examples 8-10, wherein the machine-readable instructions are to cause one or more of the at least one processor circuit to load entire weights of the selected expert before computing a language model head when the selected expert is not stored in the full hot expert buffer or the partial hot expert buffer.

Example 12 includes the at least one non-transitory machine-readable medium as defined in one or more of examples 8-11, wherein the machine-readable instructions are to cause one or more of the at least one processor circuit to update the full hot expert buffer or the partial hot expert buffer based on an expert usage frequency.

Example 13 includes the at least one non-transitory machine-readable medium as defined in one or more of examples 8-12, wherein the machine-readable instructions are to cause one or more of the at least one processor circuit to initiate a counter of global expert usage to cache globally frequent experts to increase expert hit rates based on the full hot expert buffer or the partial hot expert buffer.

Example 14 includes the at least one non-transitory machine-readable medium as defined in one or more of examples 8-13, wherein the machine-readable instructions are to cause one or more of the at least one processor circuit to perform a General Matrix Multiply (GEMM) operation in contiguous chunks for the selected expert in the partial hot expert buffer.

Example 15 includes an apparatus, comprising means for initializing to initialize a full hot expert buffer to store entire weights of an expert used with a first frequency, initialize a partial hot expert buffer to store partial weights of an expert used with a second frequency, wherein the first frequency is higher than the second frequency, means for identifying a selected expert associated with a Mixture of Experts (MoE) layer of a Large Language Model (LLM), and means for computing to perform a direct computation or a partially direct computation, the direct computation performed after determination that the selected expert is stored in the full hot expert buffer, the partially direct computation performed after determination that the selected expert is stored in the partial hot expert buffer.

Example 16 includes the apparatus as defined in examples 15, wherein the means for computing is to perform the partially direct computation by computing a portion of a language model head using cached weights.

Example 17 includes the apparatus as defined in one or more of examples 15-16, wherein the means for computing is to asynchronously prefetch non-cached weights when computing the portion of the language model head.

Example 18 includes the apparatus as defined in one or more of examples 15-17, wherein the means for computing is to load entire weights of the selected expert before computing a language model head when the selected expert is not stored in the full hot expert buffer or the partial hot expert buffer.

Example 19 includes the apparatus as defined in one or more of examples 15-18, wherein the means for initializing is to update the full hot expert buffer or the partial hot expert buffer based on an expert usage frequency.

Example 20 includes the apparatus as defined in one or more of examples 15-19, wherein the means for initializing is to initiate a counter of global expert usage to cache globally frequent experts to increase expert hit rates based on the full hot expert buffer or the partial hot expert buffer.

Example 21 includes the apparatus as defined in one or more of examples 15-20, wherein the means for computing is to perform a General Matrix Multiply (GEMM) operation in contiguous chunks for the selected expert in the partial hot expert buffer.

Example 22 includes a method, comprising initializing a full hot expert buffer to store entire weights of an expert used with a first frequency, initializing a partial hot expert buffer to store partial weights of an expert used with a second frequency, wherein the first frequency is higher than the second frequency, identifying a selected expert associated with a Mixture of Experts (MoE) layer of a Large Language Model (LLM), and performing a direct computation or a partially direct computation, the direct computation performed after determination that the selected expert is stored in the full hot expert buffer, the partially direct computation performed after determination that the selected expert is stored in the partial hot expert buffer.

Example 23 includes the method as defined in example 22, further including performing the partially direct computation by computing a portion of a language model head using cached weights.

Example 24 includes the method as defined in one or more of examples 22-23, further including asynchronously prefetching non-cached weights when computing the portion of the language model head.

Example 25 includes the method as defined in one or more of examples 22-24, further including loading entire weights of the selected expert before computing a language model head when the selected expert is not stored in the full hot expert buffer or the partial hot expert buffer.

Example 26 includes the method as defined in one or more of examples 22-25, further including updating the full hot expert buffer or the partial hot expert buffer based on an expert usage frequency.

Example 27 includes the method as defined in one or more of examples 22-26, further including initiating a counter of global expert usage to cache globally frequent experts to increase expert hit rates based on the full hot expert buffer or the partial hot expert buffer.

Example 28 includes the method as defined in one or more of examples 22-27, further including performing a General Matrix Multiply (GEMM) operation in contiguous chunks for the selected expert in the partial hot expert buffer.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
initialize a full hot expert buffer to store entire weights of an expert used with a first frequency;
initialize a partial hot expert buffer to store partial weights of an expert used with a second frequency, wherein the first frequency is higher than the second frequency;
identify a selected expert associated with a Mixture of Experts (MoE) layer of a Large Language Model (LLM); and
perform a direct computation or a partially direct computation, the direct computation performed after determination that the selected expert is stored in the full hot expert buffer, the partially direct computation performed after determination that the selected expert is stored in the partial hot expert buffer.

2. The apparatus of claim 1, wherein one or more of the at least one processor circuit is to perform the partially direct computation by computing a portion of a language model head using cached weights.

3. The apparatus of claim 2, wherein one or more of the at least one processor circuit is to asynchronously prefetch non-cached weights when computing the portion of the language model head.

4. The apparatus of claim 1, wherein one or more of the at least one processor circuit is to load entire weights of the selected expert before computing a language model head when the selected expert is not stored in the full hot expert buffer or the partial hot expert buffer.

5. The apparatus of claim 1, wherein one or more of the at least one processor circuit is to update the full hot expert buffer or the partial hot expert buffer based on an expert usage frequency.

6. The apparatus of claim 1, wherein one or more of the at least one processor circuit is to initiate a counter of global expert usage to cache globally frequent experts to increase expert hit rates based on the full hot expert buffer or the partial hot expert buffer.

7. The apparatus of claim 1, wherein one or more of the at least one processor circuit is to perform a General Matrix Multiply (GEMM) operation in contiguous chunks for the selected expert in the partial hot expert buffer.

8. At least one non-transitory machine-readable medium comprising machine-readable instructions to cause at least one processor circuit to at least:
initialize a full hot expert buffer to store entire weights of an expert used with a first frequency;
initialize a partial hot expert buffer to store partial weights of an expert used with a second frequency, wherein the first frequency is higher than the second frequency;
identify a selected expert associated with a Mixture of Experts (MoE) layer of a Large Language Model (LLM); and
perform a direct computation or a partially direct computation, the direct computation performed after determination that the selected expert is stored in the full hot expert buffer, the partially direct computation performed after determination that the selected expert is stored in the partial hot expert buffer.

9. The at least one non-transitory machine-readable medium of claim 8, wherein the machine-readable instructions are to cause one or more of the at least one processor circuit to perform the partially direct computation by computing a portion of a language model head using cached weights.

10. The at least one non-transitory machine-readable medium of claim 9, wherein the machine-readable instructions are to cause one or more of the at least one processor circuit to asynchronously prefetch non-cached weights when computing the portion of the language model head.

11. The at least one non-transitory machine-readable medium of claim 10, wherein the machine-readable instructions are to cause one or more of the at least one processor circuit to load entire weights of the selected expert before computing a language model head when the selected expert is not stored in the full hot expert buffer or the partial hot expert buffer.

12. The at least one non-transitory machine-readable medium of claim 8, wherein the machine-readable instructions are to cause one or more of the at least one processor circuit to update the full hot expert buffer or the partial hot expert buffer based on an expert usage frequency.

13. The at least one non-transitory machine-readable medium of claim 8, wherein the machine-readable instructions are to cause one or more of the at least one processor circuit to initiate a counter of global expert usage to cache globally frequent experts to increase expert hit rates based on the full hot expert buffer or the partial hot expert buffer.

14. The at least one non-transitory machine-readable medium of claim 8, wherein the machine-readable instructions are to cause one or more of the at least one processor circuit to perform a General Matrix Multiply (GEMM) operation in contiguous chunks for the selected expert in the partial hot expert buffer.

15. An apparatus, comprising:
means for initializing to:
initialize a full hot expert buffer to store entire weights of an expert used with a first frequency;
initialize a partial hot expert buffer to store partial weights of an expert used with a second frequency, wherein the first frequency is higher than the second frequency;
means for identifying a selected expert associated with a Mixture of Experts (MoE) layer of a Large Language Model (LLM); and
means for computing to perform a direct computation or a partially direct computation, the direct computation performed after determination that the selected expert is stored in the full hot expert buffer, the partially direct computation performed after determination that the selected expert is stored in the partial hot expert buffer.

16. The apparatus of claim 15, wherein the means for computing is to perform the partially direct computation by computing a portion of a language model head using cached weights.

17. The apparatus of claim 16, wherein the means for computing is to asynchronously prefetch non-cached weights when computing the portion of the language model head.

18. The apparatus of claim 15, wherein the means for computing is to load entire weights of the selected expert before computing a language model head when the selected expert is not stored in the full hot expert buffer or the partial hot expert buffer.

19. The apparatus of claim 15, wherein the means for initializing is to update the full hot expert buffer or the partial hot expert buffer based on an expert usage frequency.

20. The apparatus of claim 15, wherein the means for initializing is to initiate a counter of global expert usage to cache globally frequent experts to increase expert hit rates based on the full hot expert buffer or the partial hot expert buffer.
